(19) United States
(12) Patent Application Publication
(10) Pub. No.: US 2011/0154861 A1
(43) Pub. Date: Jun. 30, 2011

(54) MANUFACTURING METHOD FOR GLASS SUBSTRATE WITH THIN FILM

(75) Inventors: Akira Kishimoto, Otsu-shi (JP); Masashi Tabe, Otsu-shi (JP); Tsutomu Imamura, Otsu-shi (JP)

(73) Assignee: NIPPON ELECTRIC GLASS CO., LTD., Otsu-shi, Shiga (JP)

(21) Appl. No.: 13/061,187

(22) PCT Filed: Aug. 21, 2009
(86) PCT No.: PCT/JP2009/004014

§ 371 Date: Feb. 28, 2011

(30) Foreign Application Priority Data
Sep. 1, 2008 (JP) 2008-223752

(51) Int. Cl. C03B 23/023; C03C 17/00

(52) U.S. Cl. 65/60.1

(57) ABSTRACT

The invention provides a manufacturing method for a glass substrate with a thin film, which allows easy manufacturing of a less warped glass substrate with a thin film. The method performs: a deformation step of plastically deforming a glass substrate 10 to give a principal surface 10a thereof a curved shape so that the principal surface 10a of the glass substrate 10 is flattened in the final state after the formation of the thin film; and a thin film formation step of forming a thin film 11 on the principal surface 10a of the plastically deformed glass substrate 10.

### TECHNICAL FIELD

This invention relates to a manufacturing method for a glass substrate with a thin film in which the thin film is formed on a surface of the glass substrate, such as for example a wavelength cutoff filter.

### BACKGROUND ART

Various types of glass substrates with a thin film are conventionally known in which a thin film is formed on a principal surface of a glass substrate, such as an IR cutoff filter to be disposed on the light-receiving side of a image pickup device. Glass substrates with a thin film are often used to be attached to surfaces of other elements. Therefore, glass substrates with a thin film are required to have a flat principal surface. However, they have a problem in that when a thin film is formed on a glass substrate, relative contraction or expansion of the thin film in the direction along the surface thereof to the glass substrate after the formation of the thin film causes a membrane stress of the thin film in the direction along the surface thereof, whereby the glass substrate is warped. In view of such a problem, various methods for reducing the warpage of the glass substrate with a thin film are proposed, such as in Patent Literature 1.

For example, Patent Literature 1 discloses that in a totally reflective mirror in which a mirror film is formed on one principal surface of a glass substrate, a straightening film for straightening warpage is formed on the other principal surface.

### Citation List

### Patent Literature

Patent Literature 1: Published Japanese Patent Application No. 2007-241018

Patent Literature 2: Published Japanese Patent Application No. H05-251427

### SUMMARY OF INVENTION

### Technical Problem

However, the method for reducing warpage disclosed in Patent Literature 1 has a problem in that since a straightening film must be formed in addition to a mirror film, the number of necessary thin films increases, which complicates the manufacturing process for a glass substrate with a thin film and thereby increases the manufacturing cost.

On the other hand, for example, Patent Literature 2 discloses a method for manufacturing a semiconductor substrate having a thin film formed on a surface thereof, wherein the thin film is formed with the semiconductor substrate subjected to stress due to strain opposite to warpage of the semiconductor substrate resulting from the formation of the thin film. Patent Literature 2 describes that according to this method, the contractile force of the thin film and the stress due to strain applied to the semiconductor substrate are equalized, thereby obtaining a flat semiconductor substrate with a thin film.

It is conceivable to apply the method for manufacturing a semiconductor substrate with a thin film disclosed in the above Patent Literature 2 to the manufacturing of a glass substrate with a thin film. However, if the method described in Patent Literature 2 is applied to the manufacturing of a glass substrate with a thin film, the thin film must be formed while the glass substrate is held subjected to stress due to strain. This presents a problem in that the step of forming the thin film becomes complicated.

An object of the present invention is to provide a manufacturing method for a glass substrate with a thin film, which allows easy manufacturing of a less warped glass substrate with a thin film.

### Solution to Problem

A manufacturing method for a glass substrate with a thin film according to the present invention is a method for manufacturing a glass substrate with a thin film in which the thin film is formed on a principal surface of the glass substrate, the glass substrate being deformed by relative expansion or contraction of the thin film in the direction along the surface of the thin film to the glass substrate after the formation of the thin film, the method including: a deformation step of plastically deforming the glass substrate to give the principal surface thereof a curved shape so that the principal surface of the glass substrate is flattened in the final state after the formation of the thin film; and a thin film formation step of forming the thin film on the principal surface of the plastically deformed glass substrate. Thus, after the formation of the thin film, the thin film is relatively expanded or contracted in the direction along the surface of the thin film compared to the glass substrate, whereby the principal surface of the glass substrate becomes flattened. As a result, a glass substrate with a thin film having a reduced warpage can be obtained. Furthermore, in the manufacturing method for a glass substrate with a thin film according to the present invention, there is no need to form any additional thin film for reducing warpage, nor to hold the glass substrate with any stress due to strain applied thereto during the thin film formation step. Therefore, a glass substrate with a thin film can be easily manufactured.

Note that in the present invention “the final state after the formation of the thin film” means a state of the glass substrate with a thin film at the time when its manufacturing is completed. For example, if a thin film is formed by sputtering or vapor deposition, “the final state after the formation of the thin film” means that a state of a glass substrate in which the glass substrate having a thin film formed thereon has cooled down to a service temperature, such as room temperature, after the formation of the thin film. On the other hand, if a thin film is formed by a wet method, such as a sol-gel method or spin coating, “the final state after the formation of the thin film” means that a state of a glass substrate in which the drying of the formed thin film has been completed.

The plastic deformation of the glass substrate can be performed, for example, with the glass substrate heated to a temperature 50° C. lower than the strain point of the glass substrate or above. Thus, a less strained, curved glass substrate can be obtained. Therefore, the in-plane distribution of stress exerted on the thin film by the glass substrate can be reduced.

On which of the convex and concave principal surfaces a thin film is to be formed is determined depending upon the combination of thin film and glass substrate. Specifically, if a glass substrate is combined with a thin film that will apply a compressive stress to the glass substrate after the formation of the thin film, the principal surface on which a thin film is to be formed is preferably convex. On the other hand, if a glass substrate is combined with a thin film that will apply a tensile stress to the glass substrate after the formation of the thin film, the principal surface on which a thin film is to be formed is preferably concave.

Alternatively, thin films may be formed on both the principal surfaces of the glass substrate. Also in this case, a less warped glass substrate with a thin film can be obtained by applying the present invention.

Examples of the method for forming a thin film include sputtering and vapor deposition. In forming a thin film by sputtering or vapor deposition, a difference in coefficient of thermal expansion between the thin film and the glass substrate will cause a difference in amount of contraction between the thin film and the glass substrate during the cooling process after the formation of the thin film, whereby membrane stress will be likely to occur between the thin film and the glass substrate. Thus, the glass substrate is likely to become warped. Therefore, the present invention is particularly effective if, in forming a thin film, such a method involving a temperature rise in the glass substrate, such as sputtering or vapor deposition, is used.

Furthermore, if the thin film is formed by depositing a plurality of films one on another, the membrane stress of the thin film is larger, which tends to increase the warpage of the resultant glass substrate with a thin film. Therefore, the present invention is particularly effective if the thin film is formed by depositing a plurality of films one on another.

In the present invention, the thickness of the glass substrate is not particularly limited. However, the thinner the glass substrate, the more the resultant glass substrate with a thin film is likely to become warped. Therefore, the present invention is particularly effective if the glass substrate is thin. In the present invention, the particularly effective range of thicknesses of the glass substrate is from 0.1 mm to 100 mm.

In the present invention, the thickness of the thin film is also not particularly limited. However, if the thin film is relatively thick compared to the glass substrate, the resultant glass substrate with a thin film is likely to become warped. Therefore, the present invention is particularly effective if the relative thickness of the thin film to that of the glass substrate is large. In the present invention, the particularly effective range of relative thicknesses of the thin film to those of the glass substrate ((thin film thickness)/(glass substrate thickness)) is from 1/2500 to 1/20.

A specific example of the glass substrate with a thin film manufactured according to the present invention is an IR cutoff filter to be applied to an image pickup device. If an IR cutoff filter is warped, it becomes difficult to apply to an image pickup device. For this reason, the allowable amount of warpage for IR cutoff filters to be applied to image pickup devices is particularly small. Therefore, the present invention that can effectively reduce warpage can be particularly effectively used to manufacture IR cutoff filters to be applied to image pickup devices.

### ADVANTAGEOUS EFFECTS OF INVENTION

According to the present invention, a manufacturing method for a glass substrate with a thin film can be provided which allows easy manufacturing of a less warped glass substrate with a thin film.

### BRIEF DESCRIPTION OF DRAWINGS

FIG. 1 is a cross-sectional view of a glass substrate with a thin film according to a first embodiment.

FIG. 2 is a cross-sectional view of the glass substrate before a thin film is formed thereon.

FIG. 3 is a plan view of a jig for use in plastically deforming the glass substrate.

FIG. 4 is a cross-sectional view taken along the cut line IV-IV shown in FIG. 3.

FIG. 5 is a cross-sectional view of the glass substrate in a curved state.

FIG. 6 is a cross-sectional view of an image pickup device unit.

FIG. 7 is a cross-sectional view of a glass substrate with a thin film according to a third embodiment.

FIG. 8 is a plan view of a glass substrate representing points to be measured in terms of amount of warpage.

FIG. 9 is a cross-sectional view showing the step of measuring the amounts of warpage of a glass substrate.

FIG. 10 is a graph showing the relation between holding time and maximum amount of warpage of each glass substrate in an experimental example.

### DESCRIPTION OF EMBODIMENTS

### First Embodiment

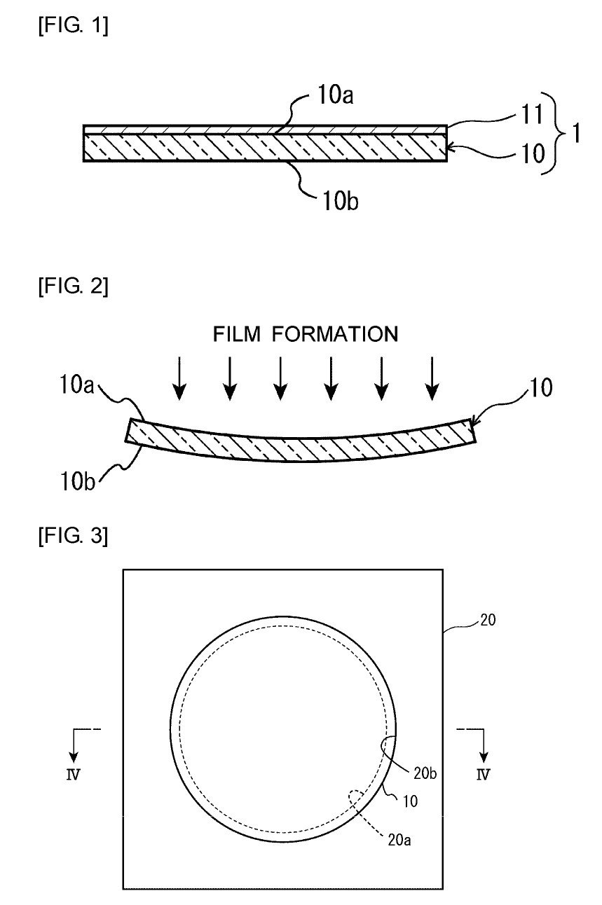

FIG. 1 is a cross-sectional view of a glass substrate 1 with a thin film to be manufactured in this embodiment. First, the structure of a glass substrate 1 with a thin film will be described with reference to FIG. 1.

As shown in FIG. 1, the glass substrate 1 with a thin film includes a glass substrate 10. The glass substrate 10 can be appropriately selected according to the characteristics of the glass substrate 1 with a thin film or other factors. The glass substrate 10 can be formed, for example, of a borosilicate glass substrate.

The glass substrate 10 has first and second principal surfaces 10a and 10b parallel to each other. Each of the first and second principal surfaces 10a and 10b is flat. A thin film 11 is formed on the first principal surface 10a. The thin film 11 can be appropriately selected according to the characteristics of the glass substrate 1 with a thin film or other factors. For example, if the glass substrate 1 with a thin film is an IR cutoff filter, an IR cutoff film can be selected as the thin film 11. On the other hand, for example, if the glass substrate 1 with a thin film is a reflective mirror, a reflective film can be selected as the thin film 11. Alternatively, for example, if the glass substrate 1 with a thin film is an antireflective substrate, an antireflective film can be selected as the thin film 11.

Next, a description will be given of a manufacturing method for a glass substrate 1 with a thin film. FIG. 2 is a cross-sectional view of a glass substrate 10 before a thin film is formed thereon. The manufacturing method of this embodiment is characterized in that the glass substrate 10 is plastically deformed, before the formation of the thin film 11, to give the first and second principal surfaces 10a and 10b of the glass substrate 10 a curved shape so that the first and second principal surfaces 10a and 10b of the glass substrate 10 can be flattened in the final state after the formation of the thin film as shown in FIG. 1, and the thin film 11 is then formed on the first or second principal surface 10a, 10b of the glass substrate 10. Specifically, FIG. 2 shows the case where a thin film 11 is formed on the convexly curved first principal surface 10a of the glass substrate 10.

Generally, when a thin film is formed on a glass substrate, a membrane stress is induced in the thin film regardless of the method for forming the thin film. For example, if in forming a thin film a method involving a temperature rise in the glass substrate, such as sputtering or vapor deposition, is used, a difference in coefficient of thermal expansion between the thin film and the glass substrate will cause a difference between the amount of contraction of the thin film in the direction along the surface thereof and the amount of contraction of the glass substrate in the direction along the surface thereof during the cooling process after the formation of the thin film. Therefore, during the cooling process after the formation of the thin film, a membrane stress is induced in the thin film in the direction along the surface thereof. Thus, if a thin film is formed, for example, on a flat glass substrate, the glass substrate will be warped during the cooling process. In other words, both the principal surfaces of the glass substrate will be curved.

By contrast, in this embodiment, as described above, the glass substrate 10 is plastically deformed, before the formation of the thin film 11, to give the first and second principal surfaces 10a and 10b of the glass substrate 10 a curved shape so that the first and second principal surfaces 10a and 10b of the glass substrate 10 can be flattened in the final state after the formation of the thin film. Therefore, by a membrane stress of the thin film 11 induced in the direction along the surface thereof after the thin film formation and an elastic force of the glass substrate 10, the first and second principal surfaces 10a and 10b are flattened in the final state after the formation of the thin film, as shown in FIG. 1. As a result, a less warped glass substrate 1 with a thin film can be obtained.

Furthermore, according to the manufacturing method of this embodiment, there is no need to form any thin film for reducing warpage nor to hold the glass substrate with any stress due to strain applied thereto during the thin film formation step. Therefore, a glass substrate 1 with a thin film can be easily manufactured.

In addition, if, for example, a thin film is formed on the glass substrate while the glass substrate is held with stress due to strain applied thereto, the contact of the glass substrate with a holder and the stress applied to the glass substrate by the holder during the thin film formation step may induce flaws, fractures or cracks in the glass substrate. By contrast, in this embodiment, the glass substrate 10 need not be held with any stress to strain applied thereto during the step of forming a thin film 11. This prevents the occurrence of flaws, fractures and cracks in the glass substrate 10.

Furthermore, in the method for forming a thin film by holding the glass substrate with stress due to strain applied thereto, a large stress due to strain must be applied to the glass substrate during the thin film formation step if a large membrane stress will be induced in the thin film during the cooling process. Therefore, the glass substrate may be damaged during the thin film formation step.

By contrast, according to the manufacturing method of this embodiment, if a large membrane stress will be induced in the thin film during the cooling process, the glass substrate need only be previously plastically deformed to a large extent and no large stress due to strain need be applied to the glass substrate. Thus, the damage to the glass substrate during the thin film formation step can be prevented. Therefore, according to the manufacturing method of this embodiment, even if the thin film 11 may exhibit a large membrane stress during the cooling process, less warped glass substrates 1 with a thin film can be manufactured with a high degree of efficiency.

In this embodiment, the thickness of the glass substrate 10 is not particularly limited. However, the smaller the thickness of the glass substrate 10, the more the glass substrate with a thin film is likely to become warped. Therefore, the manufacturing method for a glass substrate with a thin film according to this embodiment is particularly effective if the thickness of the glass substrate is small. In the manufacturing method for a glass substrate with a thin film according to this embodiment, the particularly effective range of thicknesses of the glass substrate 10 is from 0.1 mm to 10 mm.

The thickness of the thin film 11 is also not particularly limited. However, if the thin film 11 is relatively thick compared to the glass substrate 10, the resultant glass substrate with a thin film is more likely to become warped. Therefore, the manufacturing method for a glass substrate with a thin film according to this embodiment is particularly effective if the relative thickness of the thin film to that of the glass substrate is large. In the manufacturing method for a glass substrate with a thin film according to this embodiment, the particularly effective range of relative thicknesses of the thin film 11 to those of the glass substrate 10 is from 1/2500 to 1/20.

A further detailed description will be given below of individual manufacturing steps for a glass substrate 1 with a thin film.

(Step of Plastically Deforming Glass Substrate 10)

Examples of a method for plastically deforming a glass substrate 10 include the following methods (1) to (5):

(1) the method of deforming the glass substrate 10 by heating it to a temperature 50° C. lower than its strain point or above;

(2) the method of press-forming the glass substrate 10 with a forming die;

(3) the method of chemically strengthening one of the principal surfaces of the glass substrate 10;

(4) the method of polishing one of the principal surfaces of the glass substrate 10; and

(5) the method of irradiating one of the principal surfaces of the glass substrate 10 with argon plasma.

Among them, the method (1) of deforming the glass substrate 10 by heating it to a temperature 50° C. lower than its strain point or above is preferably used because of its easy operability and less likelihood of damage to the glass substrate 10.

Specifically, when the glass substrate 10 is deformed by heating it to its strain point or above, the plastic deformation of the glass substrate 10 is performed in the following manner.

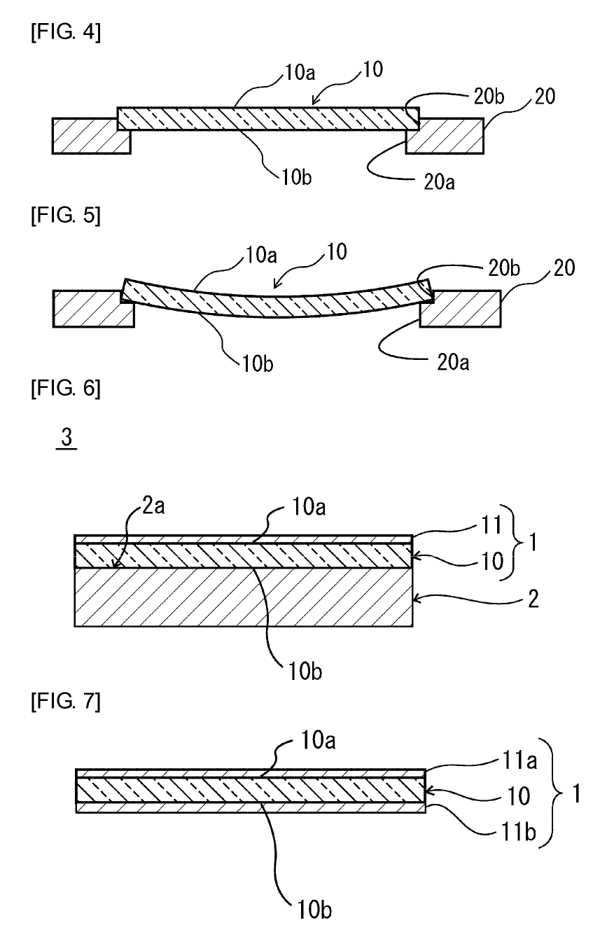

FIG. 3 is a plan view of a jig 20 for use in plastically deforming the glass substrate 10. FIG. 4 is a cross-sectional view taken along the cut line IV-IV shown in FIG. 3. As shown in FIGS. 3 and 4, the jig 20 has an opening 20a formed therein to put the glass substrate 10 in the opening 20a. A ring-shaped cutaway 20b is formed around the opening 20a in the jig 20. The glass substrate 10 is designed to be put in the cutaway 20b. The glass substrate 10 is heated to and held at a temperature 50° C. lower than the strain point of the glass substrate 10 or above while being put in the cutaway 20b.

FIG. 5 is a cross-sectional view of the glass substrate 10 heated to and held at a temperature 50° C. lower than its strain point or above. As shown in FIG. 5, when the glass substrate 10 is heated to and held at a temperature 50° C. lower than its strain point or above, the glass substrate 10 is thereby plastically deformed to have a convex shape in the vertical direction under its own weight. When in this state the glass substrate 10 is cooled down to room temperature while being put in the jig 20, there can be obtained a glass substrate 10 plastically deformed to have a generally curved shape.

Note that the temperature and holding time of the glass substrate 10 during the plastic deformation thereof can be appropriately selected according to the type of the glass substrate 10, the amount of glass substrate 10 to be deformed and other factors. Generally, the temperature at which the glass substrate 10 is to be held is preferably not lower than the temperature 50° C. lower than its strain point but not higher than its softening point, and more preferably near to or below its glass transition temperature.

The amount of glass substrate 10 to be deformed can be experimentally determined, for example, based on measurement results obtained by previously measuring the amounts of warpage of glass substrates having flat principal surfaces when thin films are formed on the glass substrates.

(Step of Forming Thin Film 11)

The method for forming a thin film 11 can be appropriately selected according to the type of the thin film 11 or other factors. Examples of the method for forming a thin film 11 include gas-phase methods, such as sputtering and vapor deposition, and wet methods, such as a sol-gel method and spin coating.

On which of the first and second principal surfaces 10a and 10b a thin film 11 is to be formed can be determined depending upon the direction of a membrane stress in the thin film 11 in the final state after the formation of the thin film. For example, if, in the final state after the formation of the thin film, the thin film 11 will apply a tensile stress in the direction along the surface of the thin film 11 to the glass substrate 10, the thin film 11 is preferably formed on the concave principal surface. On the other hand, if, in the final state after the formation of the thin film, the thin film 11 will apply a compressive stress in the direction along the surface of the thin film 11 to the glass substrate 10, the thin film 11 is preferably formed on the convex principal surface.

The manufacturing method for a glass substrate with a thin film according to this embodiment is applicable to glass substrates with a thin film in general which have a combination of a thin film 11 and a glass substrate 10 in which, after the formation of the thin film 11, the glass substrate will be deformed by relative expansion or contraction of the thin film 11 in the direction along its surface compared to the glass substrate 10. For example, the manufacturing method for a glass substrate with a thin film according to this embodiment is suitable for the manufacturing of IR cutoff filters to be applied to image pickup devices.

FIG. 6 is a cross-sectional view of an image pickup device unit 3 including an IR cutoff filter 1 applied to an image pickup device 2 and serving as a glass substrate with a thin film. The image pickup device unit 3 includes an image pickup device 2 and an IR cutoff filter 1. The image pickup device 2 is constituted, for example, by a charge coupled device (CCD) or a complementary metal-oxide semiconductor device (CMOS). A light-receiving surface 2a of the image pickup device 2 is usually formed in a flat shape. The IR cutoff filter 1 is applied onto this flat light-receiving surface 2a. Therefore, the IR cutoff filter 1 is required to have no warpage. Hence, the manufacturing method for a glass substrate with a thin film according to this embodiment, which can prevent the occurrence of warpage, can be suitably applied to the manufacturing of an IR cutoff filter 1.

Note that although the example shown in FIG. 6 has described an exemplary case where the second principal surface 10b of the glass substrate 10 is applied to the image pickup device 2, the surface of the thin film 11 opposite to the glass substrate 10 may be applied to the image pickup device 2.

### Second Embodiment

The first embodiment has described the case where a thin film 11 is formed in a single layer. However, the manufacturing method for a glass substrate with a thin film according to the present invention is applicable to the case where a thin-film stack including a plurality of thin films deposited one on another is formed on the principal surface 10a, 10b of the glass substrate 10. In this case, the membrane stress applied to the glass substrate during the cooling process is likely to be large as compared to the case where the thin film 11 is formed in a single layer. Therefore, the resultant glass substrate with a thin film tends to be largely warped. Hence, it is effective to apply to this case the manufacturing method for a glass substrate with a thin film according to the present invention.

Specific examples of the thin-film stack include multilayers formed by alternately depositing high-refractive index films, such as ZrO₂ films, TiO₂ films or Nb₂O₂ films, and low-refractive index films, such as SiO₂ films.

### Third Embodiment

The above embodiments have described the cases where a thin film 11 is formed only on one principal surface 10a of the glass substrate 10. However, the present invention is not limited to this structure.

FIG. 7 is a cross-sectional view of a glass substrate 1 with a thin film according to this embodiment. As shown in FIG. 7, thin films 11a and 11b may be formed on both the first and second principal surfaces 10a and 10b, respectively, of the glass substrate 10. The manufacturing method for a glass substrate with a thin film according to the present invention can also suitably be applied to this case.

In this embodiment, one of the thin films 11a and 11b having a larger compressive stress in the direction along the surface thereof from after the formation of the thin film to the final state is formed on the convex principal surface, while the other thin film having a larger tensile stress is formed on the concave principal surface.

### Fourth Embodiment

The above first embodiment has described the case where the glass substrate 10 has a pair of flat principal surfaces 10a and 10b. However, the shape of the glass substrate 10 is not particularly limited so long as the glass substrate 10 has a principal surface 10a. For example, the second principal surface 10b may be formed in a convex or concave shape.

### Experimental Example

In this experimental example, a series of experiments were conducted for confirming that in the step of plastically deforming the glass substrate 10, the amount of warpage of the glass substrate 10 can be controlled by changing the holding time during which the glass substrate 10 is held at a temperature equal to or above its strain point.

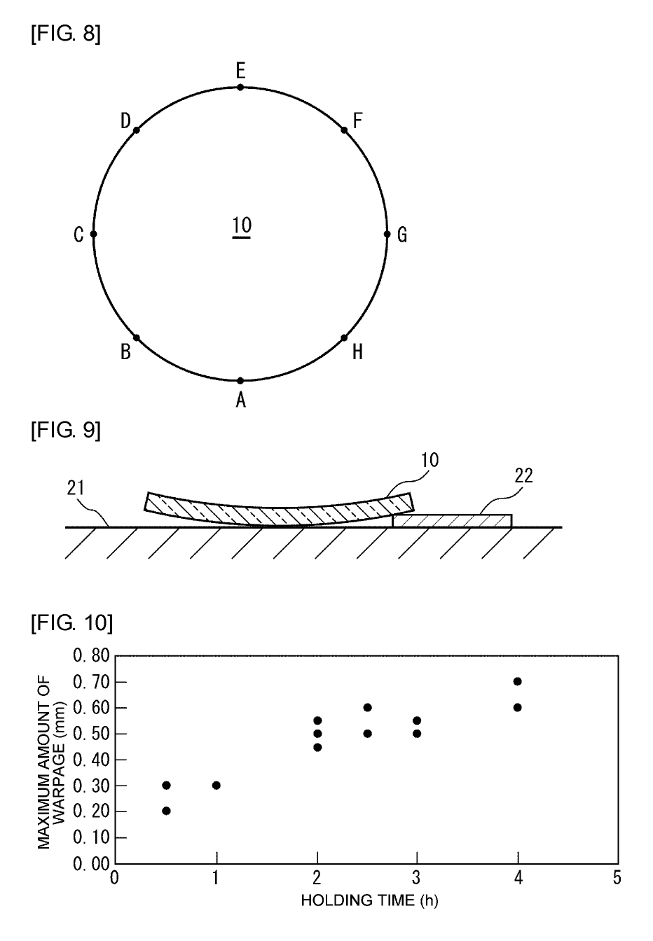

A disk-shaped glass substrate 10 (manufactured by Nippon Electric Glass Co., Ltd., product name: “ABC”, diameter: 200 mm, thickness: 0.4 mm, strain point: 650° C., glass transition point: 705° C., softening point: 950° C.) was put in the jig 20 shown in FIGS. 3 and 4, increased in temperature from room temperature to 650° C. in 15 minutes, held at 650° C. for a predetermined holding time, and then cooled down to room temperature in approximately 10 hours. Next, the amounts of warpage of the glass substrate 10 thus obtained were measured at Points A to H (see FIG. 8) set circumferentially at every 45° of central angle. Specifically, as shown in FIG. 9, the glass substrate 10 was placed on a surface plate 21 so that the glass substrate 10 took a convex shape on the side facing the surface plate 21, and the amounts of warpage of the glass substrate 10 at Points A to H were measured by inserting a thickness gauge 22 (manufactured by TSK, No. 75A10) between the surface plate 21 and the glass substrate 10 at each Point A to H. The maximum of the measured amounts of warpage at Points A to H was taken as a maximum amount of warpage of the glass substrate 10.

FIG. 10 shows the results of the experiments conducted by varying the holding time. As shown in FIG. 10, it can be seen that the maximum amount of warpage of the glass substrate 10 is increased by extending the holding time. This results show that the maximum amount of warpage of the glass substrate 10 can be controlled by changing the holding time.

### Example 1

Five disk-shaped glass substrates (manufactured by Nippon Electric Glass Co., Ltd., product name: “ABC”, diameter: 200 mm, thickness: 0.4 mm, strain point: 650° C., glass transition point: 705° C., softening point: 950° C.) were prepared, and the amounts of warpage of each glass substrate were measured in the same manner as in the above experimental example. The maximum amounts of warpage of the five glass substrates were 0 mm to 0.05 mm.

Next, each glass substrate was put in the jig 20 shown in FIGS. 3 and 4, increased in temperature from room temperature to 650° C. in 15 minutes, held at 650° C. for 2 hours and then cooled down to room temperature in approximately 10 hours. Each glass substrate after the heating was measured again in terms of amounts of warpage. The maximum amounts of warpage of the five glass substrates were 0.45 mm to 0.55 mm.

Next, a film stack including ZrO₂ films and SiO₂ films alternately deposited in 44 layers in total was formed by sputtering at approximately 130° C. on the concave principal surface of each glass substrate after the heating, thereby completing a glass substrate with a thin film. Note that the total thickness of the ZrO₂ films was approximately 2 μm, and the total thickness of the SiO₂ films was approximately 3 μm.

The glass substrates with a thin film thus obtained were measured in terms of amounts of warpage. The maximum amounts of warpage of the five glass substrates with a thin film were −0.05 mm to 0.05 mm.

As a comparative example, a thin film was formed in the same manner as in Example 1 on a flat glass substrate (manufactured by Nippon Electric Glass Co., Ltd., product name: “ABC”, diameter: 200 mm, thickness: 0.4 mm, strain point: 650° C., glass transition point: 705° C., softening point: 950° C.), and the amounts of warpage of the glass substrate were measured. The maximum amount of warpage of the flat glass substrate on which the film stack was formed was approximately 0.6 mm.

It can be seen from the above results that the amount of warpage of the glass substrate with a thin film can be reduced by curving the glass substrate prior to the formation of the thin film.

### Example 2

Five disk-shaped glass substrates (manufactured by Nippon Electric Glass Co., Ltd., product name: “ABC”, diameter: 200 mm, thickness: 0.4 mm, strain point: 650° C., glass transition point: 705° C., softening point: 950° C.) were prepared, and the amounts of warpage of each glass substrate were measured in the same manner as in the above experimental example. The maximum amounts of warpage of the five glass substrates were 0 mm to 0.05 mm.

Next, each glass substrate was put in the jig 20 shown in FIGS. 3 and 4, increased in temperature from room temperature to 650° C. in 15 minutes, held at 650° C. for 4 hours and then cooled down to room temperature in approximately 10 hours. Each glass substrate after the heating was measured again in terms of amounts of warpage. The maximum amounts of warpage of the five glass substrates were 0.6 mm to 0.7 mm.

Next, an antireflective film stack including Nb₂O₃ films and SiO₂ films alternately deposited in four layers in total was formed by sputtering at approximately 130° C. on the convex principal surface of each glass substrate after the heating. The total thickness of the Nb₂O₂ films was approximately 0.1 μm, and the total thickness of the SiO₂ films was approximately 0.2 μm.

Subsequently, an infrared cutoff film stack including Nb₂O₂ films and SiO₂ films alternately deposited in 40 layers in total was formed by sputtering at approximately 130° C. on the concave principal surface of each glass substrate, thereby completing a glass substrate with a thin film. The total thickness of the Nb₂O₂ films was approximately 1.5 μm, and the total thickness of the SiO₂ films was approximately 2.5 μm.

The glass substrates with a thin film thus obtained were measured in terms of amounts of warpage. The maximum amounts of warpage of the five glass substrates with a thin film were 0.15 mm to 0.25 mm.

As a comparative example, an infrared cutoff film stack and an antireflective film stack were formed in the same manners as in Example 2 on a flat glass substrate (manufactured by Nippon Electric Glass Co., Ltd., product name: “ABC”, diameter: 200 mm, thickness: 0.4 mm, strain point: 650° C., glass transition point: 705° C., softening point: 950° C.), and the amounts of warpage of the glass substrate were measured. The maximum amount of warpage of the flat glass substrate on which the film stacks were formed was approximately 1 mm.

It can be seen from the above results that also when thin films are formed on both surfaces of the glass substrate, the amount of warpage of the glass substrate with a thin film can be reduced by curving the glass substrate prior to the formation of the thin films.

### REFERENCE SIGNS LIST

1 . . . glass substrate
2 . . . image pickup device
2a . . . light-receiving surface
3 . . . image pickup device unit
10 . . . glass substrate
10a . . . first principal surface
10b . . . second principal surface
11, 11a, 11b . . . thin film
20 . . . jig
20a . . . opening
20b . . . cutaway
21 . . . surface plate
22 . . . thickness gauge

1. A method for manufacturing a glass substrate with a thin film in which the thin film is formed on a principal surface of the glass substrate, the glass substrate being deformed by relative expansion or contraction of the thin film in the direction along the surface of the thin film to the glass substrate after the formation of the thin film, the method comprising:
a deformation step of plastically deforming the glass substrate to give the principal surface thereof a curved shape so that the principal surface of the glass substrate is flattened in the final state after the formation of the thin film; and
a thin film formation step of forming the thin film on the principal surface of the plastically deformed glass substrate.

2. The manufacturing method for a glass substrate with a thin film according to claim 1, wherein the plastic deformation of the glass substrate is performed with the glass substrate heated to a temperature 50° C. lower than the strain point of the glass substrate or above.

3. The manufacturing method for a glass substrate with a thin film according to claim 1, wherein the deformation step comprises the step of plastically deforming the glass substrate so that the principal surface has a convex shape.

4. The manufacturing method for a glass substrate with a thin film according to claim 1, wherein the deformation step comprises the step of plastically deforming the glass substrate so that the principal surface has a concave shape.

5. The manufacturing method for a glass substrate with a thin film according to claim 1, wherein the thin film is formed by sputtering or vapor deposition.

6. The manufacturing method for a glass substrate with a thin film according to claim 1, wherein the thin film is formed by depositing a plurality of films one on another.

7. The manufacturing method for a glass substrate with a thin film according to claim 1, wherein the glass substrate with a thin film is an infrared cutoff filter to be applied to an image pickup device.
